(19) United States
(12) Patent Application Publication
(10) Pub. No.: US 2025/0272775 A1
(43) Pub. Date: Aug. 28, 2025

(54) METHOD FOR FILTERING MOBILE DEVICE DATA TO UNCOVER COMMON UNKNOWN CORRELATIONS

(71) Applicant: Geogentia, Holland, MI (US)

(72) Inventors: Brandon Gregg, Holland, MI (US); Vijay John Richard, Wesley Chapel, FL (US)

(21) Appl. No.: 19/061,939

(22) Filed: Feb. 24, 2025

Related U.S. Application Data
(60) Provisional application No. 63/556,784, filed on Feb. 22, 2024.

(51) Int. Cl. G06Q 50/26; G06F 16/29

(52) U.S. Cl. CPC G06Q 50/265; G06F 16/29

(57) ABSTRACT

A computer implemented method having the steps of: receiving a plurality of locations as selected by a user; creating an initial data set from mobile devices that have submitted ad-tech data for the plurality of locations; filtering the initial data set to identify a set of key-devices that have visited a plurality of the plurality of locations selected by the user, and providing the ad-tech data pertaining to the set of key-devices to the user.

### CROSS-REFERENCE TO RELATED APPLICATION

This application claims priority from U.S. Patent App. Ser. No. 63/556,784entitled “METHOD FOR FILTERING MOBILE DEVICE DATA TO UNCOVER COMMON UNKNOWN CORRELATIONS”, filed Feb. 22, 2024, the entire disclosure of which is hereby incorporated by reference in its entirety.

### BACKGROUND OF THE DISCLOSURE

### 1. Field of the Disclosure

The disclosure relates in general to a method for using mobile device data to investigate criminal activity, and more particularly, to a method of filtering data, particularly location and time data, received from many mobile devices at multiple locations to recognize and investigate possible criminal activity.

### 2. Background Art

Mobile devices have become so common in today's society that nearly every individual in the county carries one. These mobile devices include cell phones, tablets, blackberries, and other electronic devices which are often capable of not only communicating with cellular telephone networks, but also capable of tracking and transmitting geographic location information via GPS or other positioning networks or services. Often, applications which run or operate on these location-aware mobile devices are consistently monitoring and transmitting location information to servers owned or operated by various third parties. In some instances, location and corresponding time data may even be stored and/or transmitted by a mobile device without a user's express knowledge or understanding.

It has also become common for mobile device applications (“apps”) to sell or otherwise distribute information obtained from users, including GPS location information. This has allowed commercial entities to obtain vast amounts of information relating to the habits and movement of certain populations of peoples.

### SUMMARY OF THE DISCLOSURE

In an aspect of the disclosure, the disclosure is directed to a non-transitory computer readable medium storing instructions which, when executed by a processor, result in the processor performing a number of steps. These steps include receiving a plurality of locations as selected by a user; creating an initial data set from mobile devices that have submitted ad-tech data for the plurality of locations; filtering the initial data set to identify a set of key-devices that have visited a plurality of the plurality of locations selected by the user; and providing the ad-tech data pertaining to the set of key-devices to the user.

In some configurations, the processor further performs the step of: receiving a time frame from the user prior to the step of creating.

In some configurations, the processor further performs the step of: second filtering out coincidental or false positive/negative data prior to the step of providing.

In some configurations, the processor further performs the steps of: receiving an interest key-device from a user selected from the set of key devices; forming a pattern of life for the interest key-device; and providing the pattern of life to the user.

In some configurations, the processor further performs the steps of: receiving a plurality of interest key-devices from a user selected from the set of key devices; forming a cooperative pattern of life for the plurality of interest key-devices to determine the interaction therebetween; providing the cooperative pattern of life to the user.

In some configurations, the processor further performs the steps of: limiting the plurality of locations to no more than ten locations.

In some configurations, the processor further performs the steps of: uncovering any common unknown key locations; and providing the common unknown key locations to the user.

In another aspect of the disclosure, the disclosure is directed to a computer implemented method comprising the steps of: receiving a plurality of locations as selected by a user; creating an initial data set from mobile devices that have submitted ad-tech data for the plurality of locations; filtering the initial data set to identify a set of key-devices that have visited a plurality of the plurality of locations selected by the user; and providing the ad-tech data pertaining to the set of key-devices to the user.

In some configurations, the method comprises the step of: receiving a time frame from the user prior to the step of creating.

In some configurations, the method comprises the step of: second filtering out coincidental or false positive/negative data prior to the step of providing.

In some configurations, the method comprises the steps of: receiving an interest key-device from a user selected from the set of key devices; forming a pattern of life for the interest key-device; and providing the pattern of life to the user.

In some configurations, the method further comprises the steps of: receiving a plurality of interest key-devices from a user selected from the set of key devices; forming a cooperative pattern of life for the plurality of interest key-devices to determine the interaction therebetween; and providing the cooperative pattern of life to the user.

In some configurations, the method further comprises the step of: limiting the plurality of locations to no more than ten locations.

In some configurations, the method further comprises the steps of: uncovering any common unknown key locations; and providing the common unknown key locations to the user.

In another aspect of the disclosure the disclosure is directed to a system that has a general-purpose computing device and a system. The general-purpose computing device is associated with a user. The system includes a receiving component for receiving a plurality of locations as selected by a user; a creating component for creating an initial data set from mobile devices that have submitted ad-tech data for the plurality of locations; a filtering component for filtering the initial data set to identify a set of key-devices that have visited a plurality of the plurality of locations selected by the user; and a providing component for providing the ad-tech data pertaining to the set of key-devices to the user.

In some configurations, the system further includes a receiving component for receiving a time frame from the user prior to the step of creating.

In some configurations, the system further includes a second filtering component for second filtering out coincidental or false positive/negative data prior to the step of providing.

In some configurations, the system further includes a receiving component for receiving an interest key-device from a user selected from the set of key devices; a forming component for forming a pattern of life for the interest key-device; and a providing component for providing the pattern of life to the user.

In some configurations, the system further includes a receiving component for receiving a plurality of interest key-devices from a user selected from the set of key devices; a forming component for forming a cooperative pattern of life for the plurality of interest key-devices to determine the interaction therebetween; and a providing component for providing the cooperative pattern of life to the user.

In some configurations, the system further includes a limiting component for limiting the plurality of locations to no more than ten locations.

### BRIEF DESCRIPTION OF THE DRAWINGS

The disclosure will now be described with reference to the drawings wherein:

FIG. 1 of the drawings is a system diagram of an exemplary system for implementing the Common Unknown Method with respect to a multitude of mobile devices;

FIG. 2 of the drawings is a system diagram of an exemplary system for implementing the Common Unknown Method with respect to a multitude of mobile devices in multiple locations;

FIG. 3 of the drawings is a flow diagram of an exemplary analysis utilizing the Common Unknown Method.

FIG. 4 is a block diagram of an exemplary computing device.

### DETAILED DESCRIPTION OF THE DISCLOSURE

The following description relates to organizing, filtering, and analyzing information, such as geographic location data, received from a multitude of mobile computing devices in order to investigate or uncover device interactions or correlations which may be indicative of events such as criminal activities or enterprises. Geographic location data, among other demographic, usage, and marketing data, can be provided or obtained from location-aware mobile computing devices which often utilize application software (“apps”) in day-to-day operation. These apps upload or transmit data to centralized network computing devices or servers where it can then be further distributed to third parties for analysis, such as through the analysis method described herein, or for other various purposes.

As discussed herein, data which is received from the multitude of mobile computing devices, or “mobile devices” may be utilized to investigate or uncover alleged illegal activities, such as shoplifting or organized crime. A specific method for analyzing mobile device data is described herein and referred to as “The Common Unknown” method or algorithm. The Common Unknown Method allows for a party, often a third-party data analysist or consultant, referred to herein as the “Analyzing Party”, to utilize information received from the multitude of mobile devices, the information referred to herein as “ad-tech data”, to systematically filter common variables to find commonalities among many multitudes of data points. In some instances, the set of ad-tech data to be analyzed may contain tens of thousands or even millions of data points, though the method described herein is not limited to any specific number of data points or any specific attributes or variables of ad-tech data.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, such as cell phones, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

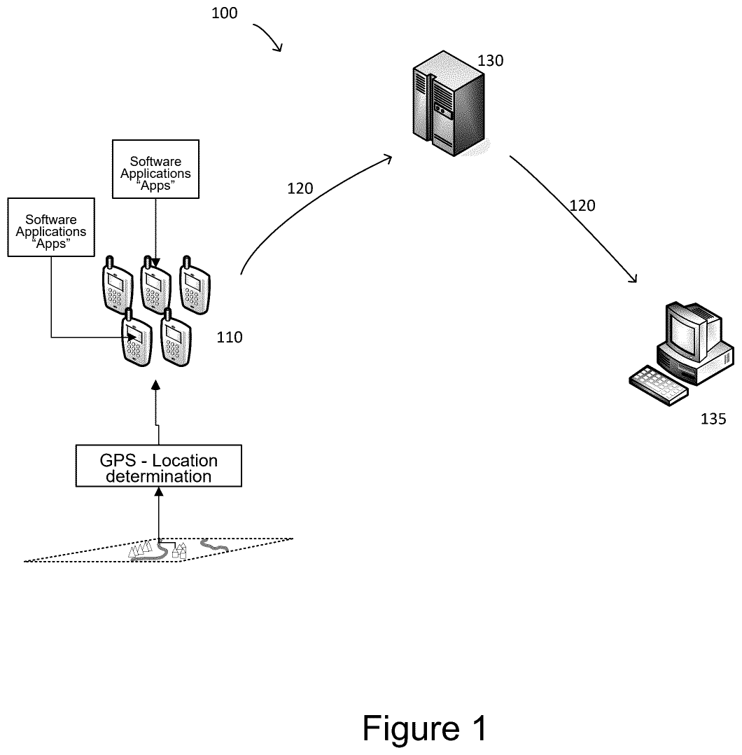

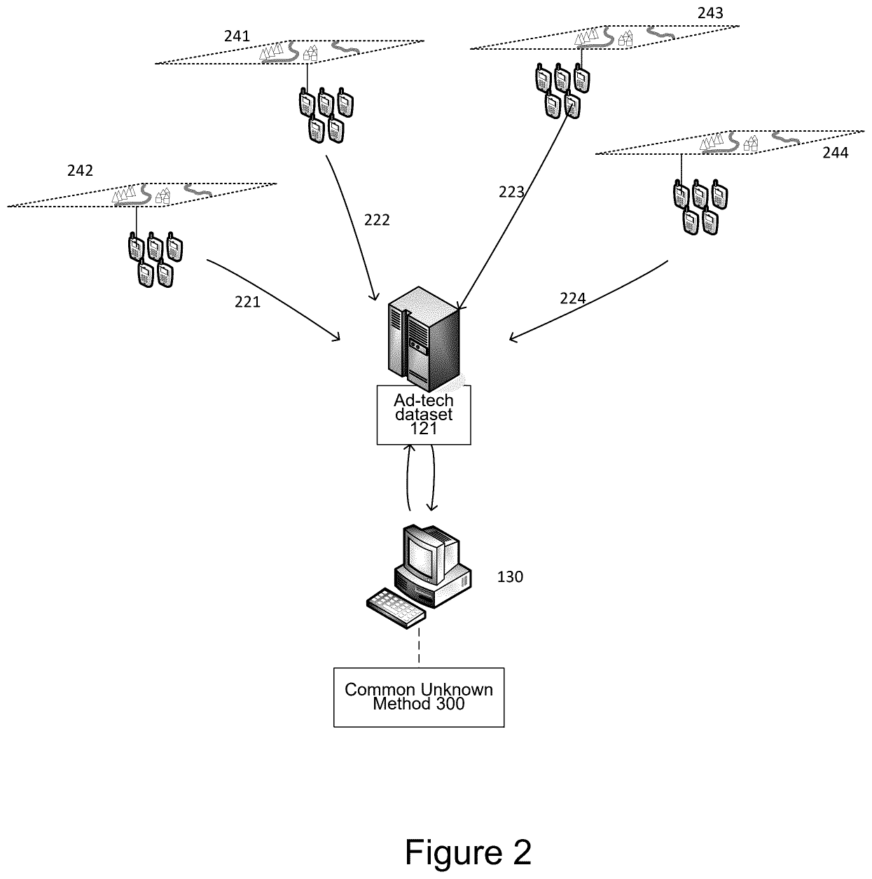

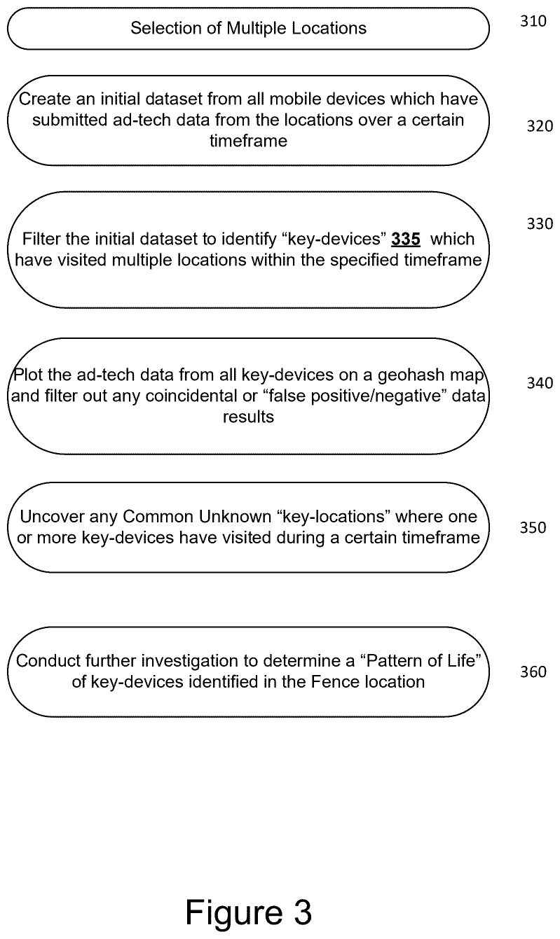

With reference to FIG. 1, an exemplary system 100 for implementing the Common Unknown Method is illustrated, providing context for the descriptions below. The exemplary system 100 is shown as comprising a multitude of mobile computing devices 110, which individually transmit various ad-tech data 120 to a centralized network computing device 130, the network computing device 130 may then further distribute the ad-tech data 120 to an Analyzing Party 135 which may then filter and analyze the sometimes massive set of ad-tech data through the algorithmic method discussed herein and further exemplified in FIGS. 2 and 3. In some instances, the ad-tech dataset may be pre-processed or filtered prior to being distributed to the Analyzing Party, as discussed in greater detail below.

After receiving a set of ad-tech data 120, an Analyzing Party may utilize the Common Unknown Method, an embodiment of which is shown in FIGS. 2 and 3, to uncover and investigate various correlations, patterns, or anomalies in the dataset, which may lead to beneficial or valuable information regarding the associated mobile device users. The Analyzing Party may start with the initial ad-tech dataset 121 which is compiled from multitudes of mobile devices at a plurality of different locations. In FIG. 2 as shown, the initial ad-tech dataset 121 is compiled from four sets of ad-tech data 221,222,223,224 from four multitudes of mobile devices at four different geographic locations 241,242,243,244. While the embodiment shown comprises four locations, it is contemplated that the number of locations may greatly vary as needed based on the implementation of the method and the objectives of the investigation or analysis. It is also contemplated, and discussed below, that there may be overlap of certain mobile devices within the multitudes of mobile devices which provide ad-tech data, meaning that a single mobile device may provide ad-tech data from more than one of the multiple locations 241, 242, 243, 244.

An initial ad-tech dataset may comprise data obtained over a specified range of time, such as a 1-hour timeframe, a weeklong timeframe, or even a multitude of weeks or years. It is also noted that the magnitude or size of the initial dataset may drastically increase as the timeline is extended, particularly in geographic locations which have high human traffic.

The ad-tech data as discussed herein may be mobile device data collected from opt-in marketing settings/services offered by third party apps which have been downloaded or utilized by the device user, though the ad-tech data is not limited to just app data. Ad-tech data may be any form and any amount of information obtained by a mobile device, either directly or through use of a third-party app. Ad-tech data as referenced in FIG. 3 is comprised of date, time, and location (latitude and longitude) information (also described as “geographic location”), but is not limited thereto. Other examples of ad-tech data may include demographic information, website or app usage, marketing preferences, or any information which may be collected by mobile devices or their respective apps, or any combination of the same. It is also contemplated that in some instances the initial ad-tech dataset 121 which is provided to the Analyzing Party 130 may be stripped of certain identifiable information, such as name, contact information, demographic information, or the like. It is contemplated that the ad-tech dataset may be altered to remove more or less information as necessary to prevent any unethical distribution of sensitive or identifying information, or to comply with any applicable privacy laws of a jurisdiction. In many instances, data provided to the Analyzing Party contains no information which may directly identify a person or individual associated with a dataset.

In an example of ad-tech data discussed herein, it is contemplated that the dataset may be comprised of timestamped geographic location information. This geographic location information may be collected and/or distributed by location-aware computing devices such as mobile phones, mobile smart phones, tablets, or other like computing devices comprising software, hardware, or combinations thereof. These mobile computing devices are often capable of obtaining real-time or delayed geographic location information. As one example, mobile cellular telephones, which are contemplated to be mobile computing devices as defined herein, often utilize Global Positioning System (GPS) hardware which may enable a device, such as the multitude of mobile devices 110, to determine its geographic location along with a corresponding timestamp in a manner well known to those skilled in the art. These location aware mobile devices are understood to allow for the sharing of geographic location, timestamp data, and other ad-tech data by means of wireless network communication, specifically to a centralized network computing device or server 130, as capable by manners well known to those skilled in the art.

In some instances, the locations 241, 242, 243, 244, as shown in FIG. 2, may comprise areas where a known crime has been committed or possibly known high crime areas, though locations are in no way limited thereto. In a specific implementation of the Common Unknown Method, further discussed as FIG. 3 herein, the locations 241, 242, 243, 244 may comprise shopping centers which are commonly targeted for shoplifting or criminal activity. In other implementations of the Common Unknown Method, locations may be comprised of multiple crime scenes where an Analyzing Party may be intending to find a common mobile device, or multiple mobile devices, which traveled to multiple specific locations during a certain period of time. It is contemplated that certain locations, such as shopping centers, may return thousands, tens of thousands, or more individual datapoints of ad-tech data, depending on the length of time in which the data is collected or requested. In a further example, the locations may comprise certain corporate business or government locations, such as corporate headquarters, research facilities, manufacturing plants, or other various locations where sensitive or otherwise secret information may be present or available.

In looking to FIG. 3, a flow diagram 300 illustrates an exemplary series of steps that can be performed to implement the Common Unknown Method as described herein. The exemplary diagram commences with step 310, wherein an Analyzing Party may select a number of locations, such as locations 241, 242, 243, 244, from which ad-tech data may be collected. As discussed above, these may be any geographic locations and in some instances may be selected by use of a graphical user interface or software program in conjunction with a computer. The selection of certain locations may be strategic in order to uncover or investigate certain mobile device user traffic or for investigation of certain criminal activity. In some instances, an Analyzing Party may select only a single geographic location to investigate, while in FIG. 2 a total of four geographic locations are investigated or analyzed. It many instances it may be suggested to select up to ten geographic locations for investigation, though the method and process described is in no way limited thereto.

In continuing the exemplary Common Unknown Method of FIG. 3, after selecting multiple geographic locations, an initial ad-tech dataset is compiled in step 320 by obtaining ad-tech data from any or all of the mobile devices which were active within the multiple locations and which provided data to a network server or computing device, such as through the means described in FIG. 1. As discussed above, this ad-tech data may comprise any information collected and provided by mobile devices or software applications functioning thereon, though in the flow diagram as provided in FIG. 3 the ad-tech data is comprised of geographic location information and associated timestamp data. Specifically, this ad-tech data, which will create the initial dataset as described in FIG. 3, is comprised of each transfer or ping of information or data which a mobile device transmits while in one or more of the geographic locations established in step 310. The exemplary communication or transfer of the ad-tech data can be established across short-range, localized, or long-range communication infrastructure, such as wireless telephone and data networks or local area networks. The initial ad-tech dataset 121, once collected or compiled, may be hosted on a centralized network computing device or server, as described in FIG. 1, or the dataset may be fully transferred for local analysis by the Analyzing Party on an off-network computer.

After making the initial dataset 121 available to the Analyzing Party 130, the initial dataset 121 is filtered in step 330 of FIG. 3 to identify specific mobile devices which were present at multiple specified locations (specifically those established in step 310) during a specified timeframe. In some applications of the Common Unknown Method, this step 330 may uncover certain mobile devices which transmitted data, or otherwise indicated geographic location, in multiple specified locations within the timeframe. More specifically, and strictly in terms of example, the filtering of the initial dataset in step 330 may allow for an Analyzing Party to recognize a number of key-devices 335 which were geographically located at multiple shopping centers within a suspicious amount of time. This sort of analysis might indicate to an Analyzing Party that the key-devices were partaking in some type of criminal activity, such as shoplifting, where it may be common to frequent multiple shopping centers within a relatively short or suspicious amount of time. It is also noted that generally, at this time, the identity of the key-device owner(s) would be unknown to the Analyzing Party, as such identifying information is generally not provided by apps or mobile devices as ad-tech data. Rather, devices are often identified by generic IDs which are provided by the ad-tech data provider and are assigned through customary methods which are known to those skilled in the art.

After identifying key-devices 335 which are of interest to an Analyzing Party, the ad-tech data of the key-devices 335 is isolated and plotted on a geohash map, as indicated in step 340. It may be necessary in some instance to obtain additional ad-tech data for the key-devices, or sufficient data may already exist in the initial ad-tech dataset 121. A geohash map, known to those skilled in the art, is an encoding method used to encode geographic coordinates, such as the latitude and longitude provided by mobile device ad-tech data, into a short string of digits and letters delineating an area on a map with varying resolutions. This allows for the Analyzing Party to easily identify areas where multiple key-devices 335 came within a certain proximity to each other or otherwise visited or frequented a common geographic location (other than those specific locations established in step 310).

As further described in step 340 of FIG. 3, it may be necessary to further filter out any coincidental or false positive or false negative data results. These may occur when, for example, key-devices 335 provide ad-tech data which may indicate that the corresponding mobile devices were located within a certain proximity of each other, but that location is simply coincidental with no relevant interaction between the devices or their human carriers, this may occur when two key-devices (after first being identified as visiting multiple specific locations 241, 242, 243, 242) simply drive through a similar intersection or stop at the same gas station. This example may be referred to as a false negative. Similarly, a false positive may occur when two key-devices 335, are subsequently shown to frequent a known criminal area or business, such as an illegal or illegitimate pawn shop or warehouse, though the key-device owners are actually not conducting any illegal or illegitimate business or activities. Both false negative and false positive interactions by the key-devices must be filtered out to effectively implement the Common Unknown Method. This additional filtering may be conducted by various means, including by not limited visual investigation or use of computer software or techniques known to those skilled in the art.

After discarding false negative and false positive interactions, Common Unknown geographic locations, termed herein as “key-location(s)”, are identified as locations of interest for further investigation or in some instances surveillance. These key-locations, in some instances, may be geographic locations where persons involved in criminal activity, such as shoplifting or organized crime, may congregate to further illegitimate or illegal actions or activities. After identifying such locations, as show in step 350 of FIG. 3, these locations may be further investigated to determine extent of the activity, in accordance with the objective of the Analyzing Party 135.

In some instances, it may be favorable for the Analyzing Party 135 to take additional step 360 in order to determine what may be called a “Pattern of Life” of the key-device persons or parties. In this step, the Analyzing Party 135 may now consider the newly uncovered key-location and pull additional ad-tech data related to said location in order to identify additional suspicious or related key-devices. Additionally, an Analyzing Party may pull ad-tech data from the prior or newly found key-devices in order to ascertain detailed travel or location information, which may in some instances be used to identify persons corresponding or related to the subject key-devices.

In a similar exemplary implementation of the Common Unknown Method, an Analyzing Party 135 may select multiple locations in step 310 to assist in uncovering possible corporate espionage or similar activities. In this instance it may be beneficial for an Analyzing Party to be aware of situations in which certain mobile devices are transmit ad-tech data from multiple locations known to house sensitive or proprietary information, such as competing research labs or corporate headquarters. To further this example, and strictly by way of example without limiting the scope of this application, an Analyzing Party may establish in step 310 the locations of a corporate headquarters and a competing corporate headquarters or research facility, the analyst may then determine in step 330 if any key-devices exist which would indicate a mobile device user which visited both locations. Step 340 would consist of filtering out any false results, such as vendors who may service both corporate entities or have other legitimate reason for traveling between the separate headquarters. What would be uncovered are any key-devices which transmitted data from both locations and may reveal a user who is communicating with competing businesses or entities. Going even a step further, an Analyzing Party may implement step 350 to determine if any of the mobile devices from competing corporate locations have additionally interacted or come within a certain proximity of one another in any locations other than those established in 310. This information could be invaluable for companies looking to deter interactions between their employees and competing entities. It is understood that the geographic locations established in step 310 are not limited to any particular size, and said locations may be sized appropriately depending on the objectives of the Analyzing Party.

It is further contemplated that an Analyzing Party may consider ad-tech data with regard to a specific order in which the established locations were visited. For example, an Analyzing Party may wish to first determine all mobile devices where transmitted ad-tech data from location 241, then subsequently determine which of those mobile devices then traveled to location 243 and location 240, in that order. This method and other similar methods of data manipulation and filtering are well within the scope of this current application. Even more, it is contemplated that an Analyzing Party may limit key-device determination to mobile devices which visit specific locations within a certain pattern criteria, and further within a certain timeframe, such as devices which visited the aforementioned locations within a 90 minute period. This filtering and manipulation may be done using computing devices and methods known to those of ordinary skill in the art.

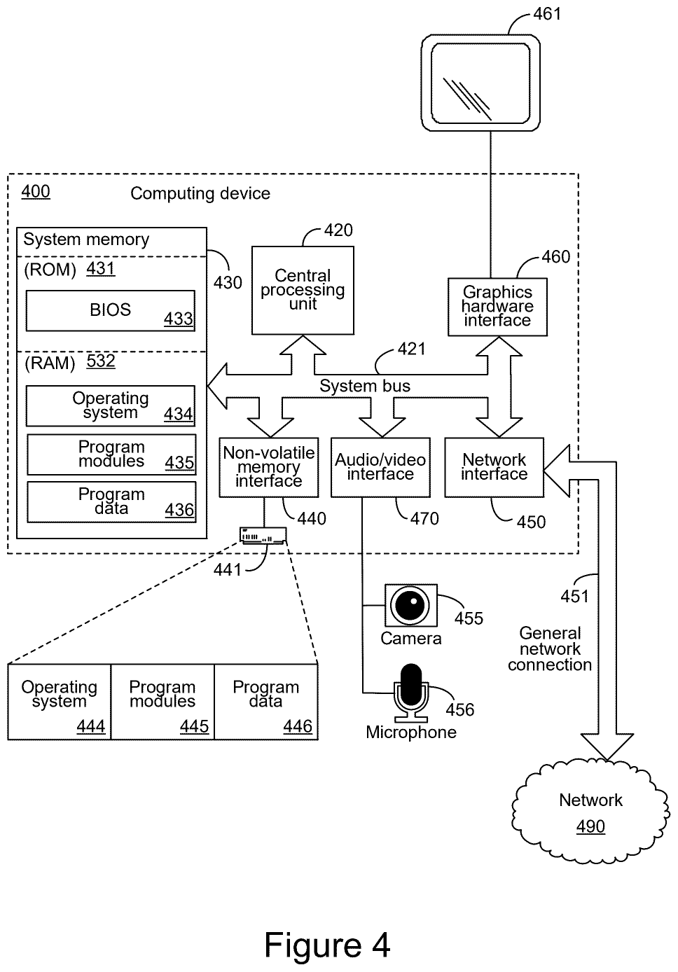

It is noted that each referenced computing device, including each individual mobile device, may be comprised of the exemplary computing device 400 as illustrated in FIG. 4. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 460 and a display device 461, which can include display devices capable of receiving touch-based user input, such as a touch-sensitive, or multi-touch capable, display device or screen. Additionally, the computing device 400 can optionally include an audio/video interface, such as the exemplary audio/video interface 470 that can be communicationally coupled to the system bus 421 and can support standardized peripheral and/or extension communication protocols to allow additional hardware devices to be communicationally coupled with the computing device 400. The exemplary camera 455 and/or microphone 456 can be part of the physical housing of the computing device 400, or can be separate peripheral hardware devices that are communicationally coupled to the exemplary computing device 400. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of content such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired content and which can be accessed by the computing device 400. Computer storage media, however, does not include communication media. Communication media typically embodies computer readable instructions, data structures, program modules or other data in a modulated data signal such as a carrier wave or other transport mechanism and includes any content delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer content between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and other computer storage media as defined and delineated above. The hard disk drive 441 is typically connected to the system bus 421 through a non-volatile memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. This is further demonstrated in FIGS. 1 and 2, wherein the multitude of mobile computing devices form a network connection with the centralized network computing device 130. The computing device 400 is illustrated as being connected to the general network connection 451 (to the network 490) through a network interface or adapter 450, which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 451. It will be appreciated that the network connections shown are exemplary and other means of establishing a communications link between computing devices may be used.

Although described as a single physical device, the exemplary computing device 400 can be a virtual computing device, in which case the functionality of the above-described physical components, such as the CPU 420, the system memory 430, the network interface 440, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 400 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example, a mobile computing device comprising: a one or more processing units; and computer-readable media comprising computer-executable instructions, which, when executed by at least some of the one or more processing units, cause the mobile computing device to: obtain a geographic location, corresponding date/timestamp, and/or other ad-tech data, said location may be obtained from the mobile device's global positioning system capabilities; transmit or transfer, wirelessly or otherwise, said location, date/time, and other ad-tech data to a separate network computing device with similar configuration as that described above; repeat this process over a specified timeline or indefinitely, generally in real time, to provide the separate network computing device with a dataset of ad-tech data. It is contemplated and described herein that a multitude of mobile computing devices will provide such data to the separate network computing device to form a robust dataset to be analyzed, as further described herein. In some instances, the dataset may be further transferred to a third-party computing device for analysis, whereas in other instances the dataset may be analyzed or utilized without any further transfer.

A second example is the mobile computing device of the first example, wherein the computer-readable media comprise further computer-executable instructions which, when executed by at least some of the one or more processing units, cause the mobile computing device to pre-process or pre-filter some or all the data before transferring to the separate network computing device.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A non-transitory computer readable medium storing instructions which, when executed by a processor, result in the processor performing the following steps:
receiving a plurality of locations as selected by a user;
creating an initial data set from mobile devices that have submitted ad-tech data for the plurality of locations;
filtering the initial data set to identify a set of key-devices that have visited a plurality of the plurality of locations selected by the user; and
providing the ad-tech data pertaining to the set of key-devices to the user.

2. The non-transitory computer readable medium of claim 1 wherein the processor further performs the step of:
receiving a time frame from the user prior to the step of creating.

3. The non-transitory computer readable medium of claim 1 wherein the processor further performs the step of:
second filtering out coincidental or false positive/negative data prior to the step of providing.

4. The non-transitory computer readable medium of claim 1 wherein the processor further performs the steps of:
receiving an interest key-device from a user selected from the set of key devices;
forming a pattern of life for the interest key-device; and
providing the pattern of life to the user.

5. The non-transitory computer readable medium of claim 1 wherein the processor further performs the steps of:
receiving a plurality of interest key-devices from a user selected from the set of key devices;
forming a cooperative pattern of life for the plurality of interest key-devices to determine the interaction therebetween; and
providing the cooperative pattern of life to the user.

6. The non-transitory computer readable medium of claim 1 wherein the processor further performs the step of:
limiting the plurality of locations to no more than ten locations.

7. The non-transitory computer readable medium of claim 1 wherein the processor further performs the steps of:
uncovering any common unknown key locations; and
providing the common unknown key locations to the user.

8. A computer implemented method comprising the steps of:
receiving a plurality of locations as selected by a user;
creating an initial data set from mobile devices that have submitted ad-tech data for the plurality of locations;
filtering the initial data set to identify a set of key-devices that have visited a plurality of the plurality of locations selected by the user; and
providing the ad-tech data pertaining to the set of key-devices to the user.

9. The method of claim 8 further comprising the step of:
receiving a time frame from the user prior to the step of creating.

10. The method of claim 8 further comprising the step of:
second filtering out coincidental or false positive/negative data prior to the step of providing.

11. The method of claim 8 further comprising the steps of:
receiving an interest key-device from a user selected from the set of key devices;
forming a pattern of life for the interest key-device; and
providing the pattern of life to the user.

12. The method of claim 8 further comprising the steps of:
receiving a plurality of interest key-devices from a user selected from the set of key devices;
forming a cooperative pattern of life for the plurality of interest key-devices to determine the interaction therebetween; and
providing the cooperative pattern of life to the user.

13. The method of claim 8 further comprising the step of:
limiting the plurality of locations to no more than ten locations.

14. The method of claim 8 further comprising the steps of:
uncovering any common unknown key locations; and
providing the common unknown key locations to the user.

15. A system comprising:
a general-purpose computing device associated with a user;
a system for providing information to the user including:
a receiving component for receiving a plurality of locations as selected by a user;
a creating component for creating an initial data set from mobile devices that have submitted ad-tech data for the plurality of locations;
a filtering component for filtering the initial data set to identify a set of key-devices that have visited a plurality of the plurality of locations selected by the user; and
a providing component for providing the ad-tech data pertaining to the set of key-devices to the user.

16. The system of claim 15 wherein further comprising:
a receiving component for receiving a time frame from the user prior to the step of creating.

17. The system of claim 15 further comprising:
a second filtering component for second filtering out coincidental or false positive/negative data prior to the step of providing.

18. The system of claim 15 further comprising:
a receiving component for receiving an interest key-device from a user selected from the set of key devices;
a forming component for forming a pattern of life for the interest key-device; and
a providing component for providing the pattern of life to the user.

19. The system of claim 15 further comprising:
a receiving component for receiving a plurality of interest key-devices from a user selected from the set of key devices;
a forming component for forming a cooperative pattern of life for the plurality of interest key-devices to determine the interaction therebetween;
a providing component for providing the cooperative pattern of life to the user.

20. The system of claim 15 further comprising:
a limiting component for limiting the plurality of locations to no more than ten locations.
